(19) United States
(12) Patent Application Publication
(10) Pub. No.: US 2024/0142902 A1
(43) Pub. Date: May 2, 2024

(54) HEAT PIPE, FIXING DEVICE, AND IMAGE FORMING APPARATUS

(71) Applicant: FUJIFILM Business Innovation Corp., Tokyo (JP)

(72) Inventors: Kiyoshi KOYANAGI, Kanagawa (JP); Jouta Kobayashi, Kanagawa (JP); Keitaro Mori, Kanagawa (JP); Kazuyoshi Itoh, Kanagawa (JP); Toshiyuki Miyata, Kanagawa (JP); Toru Inoue, Kanagawa (JP)

(73) Assignee: FUJIFILM Business Innovation Corp., Tokyo (JP)

(21) Appl. No.: 18/324,988

(22) Filed: May 28, 2023

(30) Foreign Application Priority Data
Oct. 28, 2022 (JP) 2022-173029

(51) Int. Cl. G03G 15/20

(52) U.S. Cl. CPC G03G 15/2053; G03G 2215/2003

(57) ABSTRACT

A heat pipe includes a tubular member that is a hollow member in which liquid is encapsulated and of which an inner surface is subjected to an oxidation treatment in advance and a movement section that moves the liquid encapsulated and liquefied in the tubular member along a longitudinal direction of the tubular member by means of a capillary phenomenon and of which a surface is subjected to an oxidation treatment in advance.

### CROSS-REFERENCE TO RELATED APPLICATIONS

This application is based on and claims priority under 35 USC 119 from Japanese Patent Application No. 2022-173029 filed Oct. 28, 2022.

### BACKGROUND

### (i) Technical Field

The present invention relates to a heat pipe, a fixing device, and an image forming apparatus.

### (ii) Related Art

In the related art, as techniques related to fixing devices, for example, fixing devices disclosed in JP5258386B, JP1993-289555A, or the like have already been proposed.

In JP5258386B, an image heating apparatus includes an image heating member that heats an image on a recording material at a nip portion, a heating source that supplies heat to the image heating member, a cooling fan that cools a portion of the image heating member in a longitudinal direction orthogonal to a transport direction of the recording material by sending air, and a control section that controls operations of the heating source and the cooling fan. The heating source includes a plurality of heat-generating elements of which heat generation distributions are different from each other in the longitudinal direction orthogonal to the transport direction of the recording material, the heat generation distributions can be changed by means of a change in energization ratio with respect to the plurality of heat-generating elements, and the control section controls energization of the heating source such that the amount of heat generated in a longitudinal direction region corresponding to a cooling target region of the cooling fan at the time of operation of the cooling fan is made larger than the amount of heat generated before the start of cooling.

In JP1993-289555A, a fixing device includes a fixation film driven to travel and a heating body and a pressurizing member that come into pressure contact with each other with the fixation film interposed therebetween. In the fixing device, a recording material carrying an unfixed visual image is introduced into a space between the fixation film and the pressurizing member of a fixing nip portion formed through pressurization between the heating body and the pressurizing member with the fixation film interposed therebetween so that the recording material moves and passes through the fixing nip portion together with the traveling fixation film, heat energy is applied to the recording material from the heating body via the fixation film, and the visual image is heated and fixed. A high-thermal-conductivity member having a thermal conductivity of 100 [kcal/mhr° C.] or more is provided on a side opposite to an abutment surface with respect to the fixation film of the heating body.

### SUMMARY

Aspects of non-limiting embodiments of the present disclosure relate to a heat pipe of which a favorable thermal conduction performance can be maintained along a longitudinal direction for a long period of time and a fixing device and an image forming apparatus using the heat pipe.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a heat pipe including a tubular member that is a hollow member in which liquid is encapsulated and of which an inner surface is subjected to an oxidation treatment in advance and a movement section that moves the liquid encapsulated and liquefied in the tubular member along a longitudinal direction of the tubular member by means of a capillary phenomenon and of which a surface is subjected to an oxidation treatment in advance.

### BRIEF DESCRIPTION OF THE DRAWINGS

Exemplary embodiment(s) of the present invention will be described in detail based on the following figures, wherein:

FIG. 1 is an overall configuration diagram showing an image forming apparatus to which a fixing device according to Exemplary Embodiment 1 of the present invention is applied;

FIG. 2 is a cross-sectional configuration diagram showing the fixing device according to Exemplary Embodiment 1 of the present invention;

FIG. 3 is a cross-sectional configuration diagram showing a heating belt;

FIG. 4 is a plan configuration diagram showing heat-generating portions of a ceramic heater;

FIG. 5 is a cross-sectional configuration diagram showing a major part of the fixing device according to Exemplary Embodiment 1 of the present invention;

FIG. 6 is a graph showing the heat generation temperature of the ceramic heater;

FIG. 7 is a perspective configuration diagram showing a state in which recording paper having a short length in a direction intersecting a transport direction is fixed;

FIG. 8 is a graph showing the action of the fixing device according to Exemplary Embodiment 1 of the present invention;

FIG. 9 is a cross-sectional configuration diagram showing a heat pipe according to Exemplary Embodiment 1 of the present invention;

FIG. 10 is a schematic diagram showing the action of the heat pipe according to Exemplary Embodiment 1 of the present invention;

FIG. 11 is a graph showing the way in which the thermal conduction performance of a heat pipe in the related art changes with time;

FIG. 12 is a diagram showing a firing time of the heat pipe according to Exemplary Embodiment 1 of the present invention; and

FIG. 13 is a graph showing the way in which the thermal conduction performance of the heat pipe according to Exemplary Embodiment 1 of the present invention changes with time.

### DETAILED DESCRIPTION

Hereinafter, exemplary embodiments of the present invention will be described with reference to the drawings.

### Exemplary Embodiment 1

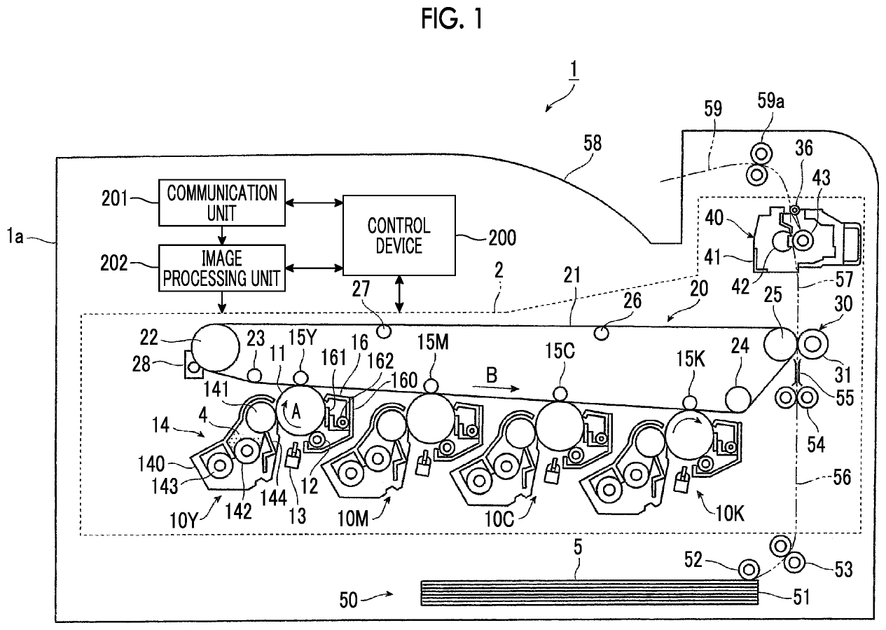

FIG. 1 shows an image forming apparatus to which a fixing device according to Exemplary Embodiment 1 is applied.

Overall Configuration of Image Forming Apparatus

An image forming apparatus 1 according to Exemplary Embodiment 1 is configured as, for example, a color printer. The image forming apparatus 1 includes a plurality of image creating devices 10 that form toner images developed with a toner constituting a developer 4, an intermediate transfer device 20 that holds a toner image formed by each image creating device 10 and finally transports the held toner image to a secondary transfer position where the transported toner image is secondarily transferred to recording paper 5 serving as an example of a recording medium, a paper feed device 50 that accommodates and transports required recording paper 5 to be supplied to the secondary transfer position of the intermediate transfer device 20, a fixing device 40 that fixes the toner image on the recording paper 5 secondarily transferred by the intermediate transfer device 20 and that serves as an example of a fixing section, and the like. The plurality of image creating devices 10 and the intermediate transfer device 20 constitute an image forming section 2 that forms an image on the recording paper 5. In addition, la in the figure indicates an apparatus body of the image forming apparatus 1, and the apparatus body 1a is formed of a supporting structural member, an exterior cover, and the like. Additionally, a two-dot chain line in the figure indicates a major transport route along which the recording paper 5 is transported in the apparatus body 1a. The image forming section 2 is not limited to an image forming section that forms a full-color image, and it is a matter of course that the image forming section 2 may be an image forming section that forms a monochrome image.

The image creating devices 10 include four image creating devices 10Y, 10M, 10C, and 10K that exclusively form toner images in four colors of yellow (Y), magenta (M), cyan (C), and black (K), respectively. The four image creating devices 10 (Y, M, C, K) are disposed to be arranged in a row in an inclined state in an internal space of the apparatus body 1a.

The four image creating devices 10 include yellow (Y), magenta (M), and cyan (C) color image creating devices 10 (Y, M, C) and a black (K) image creating device 10K. The black image creating device 10K is disposed on the most downstream side along a movement direction B of an intermediate transfer belt 21 of the intermediate transfer device 20. The image forming apparatus 1 includes, as image forming modes, a full-color mode in which the color image creating devices 10 (Y, M, C) and the black (K) image creating device 10K are operated to form a full-color image, and a black-and-white mode in which only the black (K) image creating device 10K is operated to form a black-and-white (monochrome) image.

As shown in FIG. 1, each of the image creating devices 10 (Y, M, C, K) includes a rotating photoconductive drum 11 serving as an example of an image holder, and each device serving as an example of the following toner image forming section is disposed around the photoconductive drum 11 as major devices. The major devices are a charging device 12 that charges a peripheral surface (image holding surface) of the photoconductive drum 11, on which an image can be formed, to a required potential, an exposure device 13 that irradiates the charged peripheral surface of the photoconductive drum 11 with light based on information (signal) of an image to form an electrostatic latent image (for each color) having a potential difference, a developing device 14 (Y, M, C, K) that develops the electrostatic latent image with a toner of the developer 4 for a corresponding color (Y, M, C, K) to form a toner image, a primary transfer device 15 (Y, M, C, K) that transfers each toner image to the intermediate transfer device 20 and that serves as an example of a primary transfer section, and a drum cleaning device 16 (Y, M, C, K) that remove and clean a deposit such as the toner remaining on and adhering to the image holding surface of the photoconductive drum 11 after primary transfer.

The photoconductive drum 11 has an image holding surface having a photoconductive layer (photosensitive layer) made of a photosensitive material formed on a peripheral surface of a cylindrical or columnar base material to be subjected to ground treatment. The photoconductive drum 11 is supported such that power is transmitted thereto from a drive device (not shown) and the photoconductive drum 11 rotates in a direction indicated by arrow A.

The charging device 12 includes a contact type charging roll that is disposed in contact with the photoconductive drum 11. A charging voltage is supplied to the charging device 12. As the charging voltage, in a case where the developing device 14 performs reverse development, a voltage or current having the same polarity as the charging polarity of the toner supplied from the developing device 14 is supplied. In addition, as the charging device 12, a non-contact type charging device such as a scorotron disposed on the surface of the photoconductive drum 11 in a non-contact state may be used.

The exposure device 13 consists of an LED printhead that irradiates the photoconductive drum 11 with the light according to the image information by light emitting diodes (LEDs) serving as a plurality of light emitting elements arranged in an axial direction of the photoconductive drum 11 to form an electrostatic latent image. Note that, a device that performs deflection and scanning along the axial direction of the photoconductive drum 11 with laser light configured according to the image information may be used as the exposure device 13.

All of the developing devices 14 (Y, M, C, K) are configured such that a developing roll 141 that holds the developer 4 to transport the developer 4 to a developing region that faces the photoconductive drum 11, agitating and transporting members 142 and 143 such as two screw augers that transports the developer 4 to pass through the developing roll 141 while agitating the developer 4, a layer thickness regulating member 144 that regulates the amount (layer thickness) of the developer held on the developing roll 141, and the like are disposed inside a housing 140 in which an opening portion and an accommodation chamber of the developer 4 are formed. A developing voltage is supplied to the developing device 14 from a power supply device (not shown) between the developing roll 141 and the photoconductive drum 11. Additionally, the developing roll 141 and the agitating and transporting members 142 and 143 rotate in a required direction with power transmitted thereto from a drive device (not shown). Furthermore, as the four-color developers 4 (Y, M, C, K), two-component developers containing a non-magnetic toner and a magnetic carrier are used.

The primary transfer device 15 (Y, M, C, K) is a contact type transfer device including a primary transfer roll that rotates around the photoconductive drum 11 in contact therewith via the intermediate transfer belt 21 and is supplied with a primary transfer voltage. As the primary transfer voltage, a direct-current voltage indicating a polarity opposite to the charging polarity of the toner is supplied from the power supply device (not shown).

The drum cleaning device 16 includes a container-shaped main body 160 that partially opens, a cleaning plate 161 that is disposed to be in contact with the peripheral surface of the photoconductive drum 11 after the primary transfer at a required pressure and removes and cleans deposits such as residual toner, a delivery member 162 such as a screw auger that recovers the deposits such as toner removed by the cleaning plate 161 and transports the deposits for delivery to a recovery system (not shown), and the like. As the cleaning plate 161, a plate-shaped member (for example, a blade) made of a material such as rubber is used.

As shown in FIG. 1, the intermediate transfer device 20 is disposed to be present at a position above each image creating device 10 (Y, M, C, K). The intermediate transfer device 20 includes, as major components, the intermediate transfer belt 21 that rotates in a direction indicated by arrow B while passing through a primary transfer position between the photoconductive drum 11 and the primary transfer device 15 (primary transfer roll), a plurality of belt support rolls 22 to 27 that hold the intermediate transfer belt 21 in a desired state from an inner surface thereof and rotatably support the intermediate transfer belt 21, a secondary transfer device 30 serving as an example of a secondary transfer section that is disposed on an outer peripheral surface (image holding surface) side of the intermediate transfer belt 21 supported by the belt support roll 25 and secondarily transfers an toner image on the intermediate transfer belt 21 to the recording paper 5, and a belt cleaning device 28 that removes and cleans deposits such as toner and paper dust remaining on and adhering to the outer peripheral surface of the intermediate transfer belt 21 after passing through the secondary transfer device 30.

As the intermediate transfer belt 21, for example, an endless belt made of a material in which a resistance modifier such as carbon black is dispersed in a synthetic resin such as a polyimide resin or a polyamide resin is used. Additionally, the belt support roll 22 is configured as a drive roll that is rotationally driven by the drive device (not shown) that also serves as a counter roll of the belt cleaning device 28, the belt support roll 23 is configured as a face-out roll that forms an image forming surface of the intermediate transfer belt 21, the belt support roll 24 is configured as a tension applying roll that applies tension to the intermediate transfer belt 21, the belt support roll 25 is configured as a counter roll that faces the secondary transfer device 30, and the belt support rolls 26 and 27 are configured as driven rolls of the intermediate transfer belt 21.

As shown in FIG. 1, the secondary transfer device 30 is a contact type transfer device including a secondary transfer roll 31, which rotates in contact with a peripheral surface of the intermediate transfer belt 21 and is supplied with a secondary transfer voltage, at the secondary transfer position that is an outer peripheral surface portion of the intermediate transfer belt 21 supported by the belt support roll 25 in the intermediate transfer device 20. Additionally, a direct-current voltage showing the opposite polarity or the same polarity as the charging polarity of the toner is supplied to the secondary transfer roll 31 or the belt support roll 25 of the intermediate transfer device 20 from the power supply device (not shown) as the secondary transfer voltage.

The fixing device 40 is configured such that a heating belt 42 that is rotated in a direction indicated by an arrow and heated by a heating section such that the surface temperature is maintained at a predetermined temperature, a pressure roll 43 that is in contact with the heating belt 42 at a predetermined pressure and rotates substantially in an axial direction of the heating belt 42, and the like are disposed inside a housing 41 in which an introduction port and an ejection port of the recording paper 5 are formed. In the fixing device 40, a contact portion where the heating belt 42 and the pressure roll 43 are in contact with each other is a fixing treatment portion that performs a required fixing treatment (heating and pressurizing). In addition, the fixing device 40 will be described in detail below.

The paper feed device 50 is disposed to be present at a position below the image creating device 10 (Y, M, C, K). The paper feed device 50 includes, as major components, a single (or a plurality of) paper accommodation body 51 that accommodates the recording paper 5 of a desired size, type, or the like in a loaded state, and a delivery device 52 that delivers recording paper 5 sheet by sheet from the paper accommodation body 51. The paper accommodation body 51 is attached such that the paper accommodation body 51 can be pulled out to a front side (a side surface facing a user during operation) of the apparatus body 1a, for example.

Examples of the recording paper 5 include thin paper such as plain paper and tracing paper, OHP sheets, or the like, which are used in electrophotographic copying machines and printers. In order to further improve the smoothness of an image surface after fixing, for example, it is preferable that the surface of the recording paper 5 is as smooth as possible. For example, coated paper in which the surface of plain paper is coated with resin or the like, so-called thick paper such as art paper for printing, or the like having a relatively large basis weight can also be suitably used.

A paper feed transport route 56 including a single or a plurality of paper transport roll pairs 53 and 54, which transport the recording paper 5 delivered from the paper feed device 50 to the secondary transfer position, and a transport guide 55 is provided between the paper feed device 50 and the secondary transfer device 30. The paper transport roll pair 54 disposed at a position immediately before the secondary transfer position in the paper feed transport route 56 is configured as, for example, a roll (registration roll) that adjusts the transport timing of the recording paper 5. Additionally, a paper transport route 57 for transporting the recording paper 5 after the secondary transfer, which is delivered from the secondary transfer device 30, to the fixing device 40 is provided between the secondary transfer device 30 and the fixing device 40. Moreover, an ejection transport route 59 including a paper ejection roll pair 59a for ejecting the recording paper 5 after fixing, which is delivered from the fixing device 40 by an outlet roll 36, to a paper ejection portion 58 on an upper portion of the apparatus body 1a is provided in a portion of the image forming apparatus 1 near the paper ejection port formed in the apparatus body 1a.

Reference sign 200 in FIG. 1 indicates a control device that comprehensively controls the operation of the image forming apparatus 1. The control device 200 includes a central processing unit (CPU), a read only memory (ROM), a random access memory (RAM) (not shown), a bus for connecting the CPU, the ROM, and the like to each other, a communication interface, and the like. Additionally, reference sign 201 indicates a communication unit in which the image forming apparatus 1 communicates with an external device, and reference sign 202 indicates an image processing unit that processes image information input via the communication unit 201.

Operation of Image Forming Apparatus

Hereinafter, the basic image forming operation by the image forming apparatus 1 will be described.

Here, first, the operation in the full-color mode in which a full-color image configured by combining toner images of four colors (Y, M, C, K) is formed using the four image creating devices 10 (Y, M, C, K) will be is described.

Regarding the image forming apparatus 1, in a case where the control device 200 receives request command information for a full-color image forming operation (printing) from an user interface, a printer driver, or the like (not shown) via the communication unit 201, the control device 200 starts the four image creating devices 10 (Y, M, C, K), the intermediate transfer device 20, the secondary transfer device 30, the fixing device 40, and the like.

Then, in each image creating device 10 (Y, M, C, K), as shown in FIG. 1, each photoconductive drum 11 first rotates in the direction indicated by the arrow A, and each charging device 12 charges the surface of the photoconductive drum 11 to a required polarity (negative polarity in Exemplary Embodiment 1) and a required potential. Subsequently, the exposure device 13 irradiates the surface of the photoconductive drum 11 after charging with light emitted on the basis of image signals obtained by converting the image information input to the image forming apparatus 1 into each color component (Y, M, C, K) by the image processing unit 202, and forms an electrostatic latent image of each color component configured with a required potential difference on the surface thereof.

Subsequently, each image creating device 10 (Y, M, C, K) supplies a toner of a corresponding color (Y, M, C, K) charged with a required polarity (negative polarity) from the developing roll 141 to the electrostatic latent image of each color component formed on the photoconductive drum 11 and causes the toner to electrostatically adhere to the electrostatic latent image for development. By virtue of this development, the electrostatic latent images of the respective color components formed on the respective photoconductive drums 11 are visualized as toner images of four colors (Y, M, C, K) developed with the toners of the corresponding colors.

Subsequently, in a case where the toner image of each color formed on the photoconductive drum 11 of each image creating device 10 (Y, M, C, K) is transported to the primary transfer position, the primary transfer device 15 (Y, M, C, K) primarily transfers the toner image of each color in a state in which the toner image of each color is sequentially superimposed on the intermediate transfer belt 21 while rotating in the direction indicated by the arrow B of the intermediate transfer device 20.

Additionally, in each image creating device 10 (Y, M, C, K) in which the primary transfer is completed, the drum cleaning device 16 removes deposits to scrape off the deposits and cleans the surface of the photoconductive drum 11. Accordingly, each image creating device 10 (Y, M, C, K) is in a state in which the next image creating operation can be performed.

Subsequently, the intermediate transfer device 20 holds the toner image that is primarily transferred by the rotation of the intermediate transfer belt 21 and transports the toner image to the secondary transfer position. Meanwhile, in the paper feed device 50, the required recording paper 5 is delivered to the paper feed transport route 56 in conformity with the image creating operation. In the paper feed transport route 56, the paper transport roll pair 54 serving as the registration roll delivers and supplies the recording paper 5 to the secondary transfer position in conformity with a transfer timing.

At the secondary transfer position, the secondary transfer device 30 collectively secondarily transfers the toner image on the intermediate transfer belt 21 to the recording paper 5. Additionally, in the intermediate transfer device 20 in which the secondary transfer is completed, the belt cleaning device 28 removes and cleans the deposits such as toner remaining on the surface of the intermediate transfer belt 21 after the secondary transfer.

Subsequently, the recording paper 5 on which the toner image is secondarily transferred is peeled off from the intermediate transfer belt 21 and then transported to the fixing device 40 via the paper transport route 57. In the fixing device 40, by introducing and passing the recording paper 5 after the secondary transfer into and through the contact portion between the rotating heating belt 42 and the pressure roll 43, the required fixing treatment (heating and pressurizing) is performed, and an unfixed toner image is fixed on the recording paper 5. Finally, the recording paper 5 after the fixing is completed is ejected to, for example, the paper ejection portion 58 installed in the upper portion of the apparatus body 1a by the paper ejection roll pair 59a.

By the above operation, the recording paper 5 on which the full-color image configured by combining the toner images of four colors is formed is output.

Configuration of Fixing Device

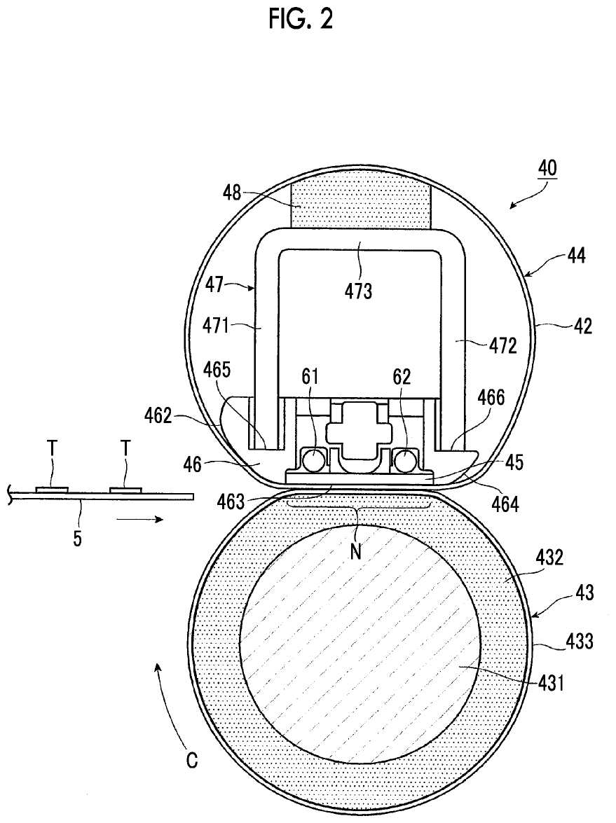

FIG. 2 is a cross-sectional configuration diagram showing the fixing device according to Exemplary Embodiment 1.

As the fixing device 40, a so-called free belt nipping type fixing device has been adopted. As shown in FIG. 2, the fixing device 40 mainly includes a heating unit 44 serving as an example of a heating device having the heating belt 42 serving as an example of a first rotating body consisting of a rotating endless belt, and the pressure roll 43 serving as an example of a second rotating body being in pressure contact with the heating unit 44. A fixing nip portion N, which is a region through which the recording paper 5 serving as an example of a heating target (fixation target member) holding an unfixed toner image T serving as an example of an unfixed image passes, is formed between the heating belt 42 and the pressure roll 43. In addition, the recording paper 5 is transported with a center in a direction intersecting a transport direction as a reference (so-called center registration).

As shown in FIG. 2, the heating unit 44 includes the heating belt 42, a ceramic heater 45 serving as an example of a planar heat-generating member that is disposed inside the heating belt 42 and heats the heating belt 42, a support member 46 serving as an example of a supporting section that is also disposed inside the heating belt 42 and supports the ceramic heater 45 to be in pressure contact with a surface of the pressure roll 43 via the heating belt 42, a holding member 47 serving as an example of a holding section that is also disposed inside the heating belt 42 and holds the support member 46 to be in pressure contact with the pressure roll 43, and a felt member 48 serving as an example of a lubricant holding section that is disposed inside the heating belt 42 and holds a lubricant applied to an inner peripheral surface of the heating belt 42.

In addition, in the ceramic heater 45 serving as an example of the planar heat-generating member, as will be described later, a heat-generating portion itself does not need to be planar and the heat-generating portion may be linearly formed as long as a lower end surface of the ceramic heater that heats the heating belt 42 is planar.

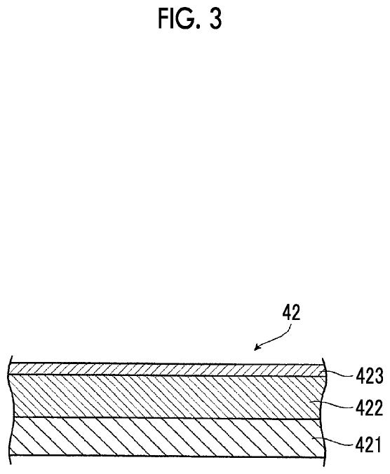

The heating belt 42 is made of a material having flexibility and is configured as an endless belt in which a free shape thereof is thin-walled cylindrical in a state before mounting. As shown in FIG. 3, the heating belt 42 includes a base material layer 421, an elastic body layer 422 coated on a surface of the base material layer 421, and a release layer 423 coated on a surface of the elastic body layer 422. The heating belt 42 does not necessarily include all of the base material layer 421, the elastic body layer 422, and the release layer 423. The heating belt 42 may be composed of only the base material layer 421 or may be composed of the base material layer 421, the release layer 423, and the like. The base material layer 421 is formed of a heat-resistant synthetic resin such as polyimide, polyamide, or polyamideimide, or a thin metal such as stainless steel, nickel, and copper. The elastic body layer 422 is made of a heat-resistant elastic body such as silicone rubber or fluororubber. The release layer 423 is formed of perfluoroalkoxyalkane (PFA), polytetrafluoroethylene (PTFE), or the like. The thickness of the heating belt 42 can be set to, for example, about 50 to 200 μm.

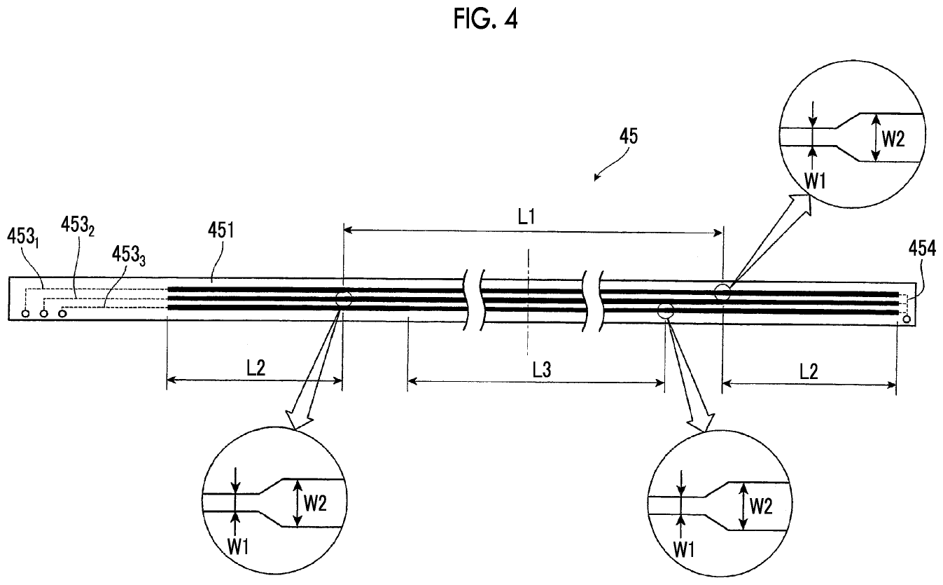

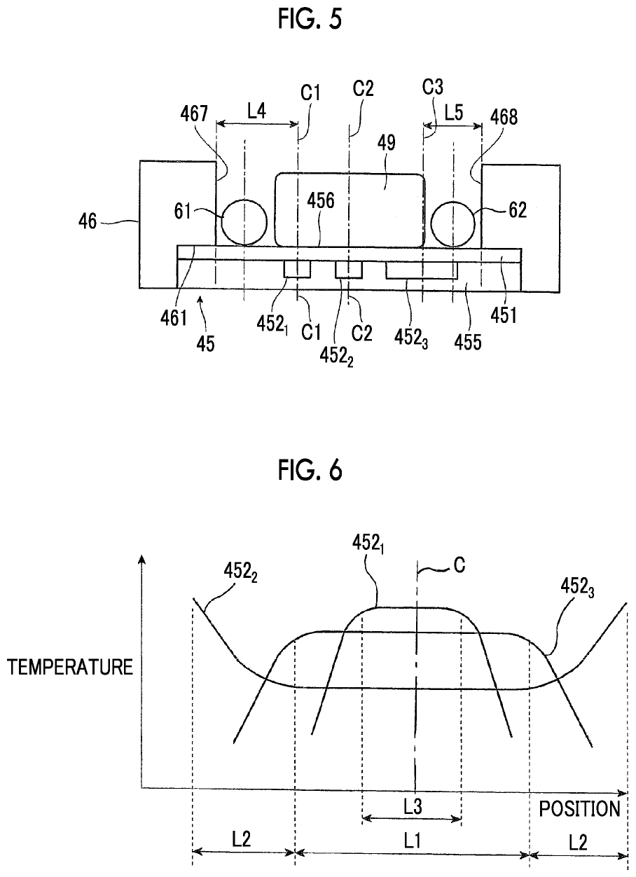

As shown in FIGS. 4 and 5, the ceramic heater 45 includes a ceramic substrate 451, a plurality of first to third heat-generating portions 452₁ to 452₃ linearly formed in the longitudinal direction on the surface of the substrate 451, first to third electrodes 453₁ to 453₃ for individually energizing the first to third heat-generating portions 452₁ to 452₃, a common electrode 454 that commonly energizes the other end portions of the first to third heat-generating portions 452₁ to 452₃, and a glass coating layer 455 that is coated on surfaces of at least the first to third heat-generating portions 452₁ to 452₃.

As shown in FIG. 4, the first to third heat-generating portions 452₁ to 452₃ are disposed to be parallel to each other along a width direction of the substrate 451. Regarding the first to third heat-generating portions 452₁ to 452₃, the line widths and/or the thicknesses of heat-generating materials constituting the first to third heat-generating portions 452₁ to 452₃ are made different from each other so that heat-generating regions along the longitudinal direction of the first to third heat-generating portions 452₁ to 452₃ are set to be different from each other. In addition, the lengths of the first to third heat-generating portions 452₁ to 452₃ are set to be equal in the longitudinal direction.

Regarding the first heat-generating portion 452₁, the line width of a heat-generating material in a region of a length L1, which is positioned at a center C of the heat-generating region, is set to be small for large electrical resistance so that heat is generated over the region of the length L1 right and left with respect to the center C of the heat-generating region in the longitudinal direction. Regarding the first heat-generating portion 452₁, the line widths of heat-generating materials in regions positioned at both end portions of the length L1 are set to be large for small electrical resistance so that heat is not generated or a very small amount of heat is generated even in the case of heat generation.

Regarding the second heat-generating portion 452₂, contrary to the first heat-generating portion 452₁, the line widths of heat-generating materials in regions other than the length L1, which are positioned to the right and the left of the center C in the longitudinal direction, are set to be small so that heat is generated over the regions other than the length L1 right and left with respect to the center C in the longitudinal direction. Regarding the second heat-generating portion 452₂, the line widths of heat-generating materials in regions positioned at both end portions of the length L1 are set to be large so that heat is not generated or a very small amount of heat is generated even in the case of heat generation.

Regarding the third heat-generating portion 452₃, unlike the first and second heat-generating portions 452₁ and 452₂, the line width of a heat-generating material in a region of a length L3, which is positioned at the center C of the heat-generating region, is set to be small for large electrical resistance so that heat is generated over the region of the length L3 right and left with respect to the center C of the heat-generating region in the longitudinal direction. Regarding the third heat-generating portion 452₃, the line widths of heat-generating materials in regions positioned at both end portions of the length L3 are set to be large for small electrical resistance so that heat is not generated or a very small amount of heat is generated even in the case of heat generation.

FIG. 6 is a graph schematically showing the heat generation temperatures of the first to third heat-generating portions 452₁ to 452₃.

As shown in FIG. 6, the first heat-generating portion 452₁ generates heat over the region of the length L1 right and left with respect to the center C of the heat-generating region in the longitudinal direction such that a set temperature set in advance is reached. The second heat-generating portion 452₂ generates heat over the regions other than the length L1 right and left with respect to the center C in the longitudinal direction such that a set temperature set in advance is reached. The third heat-generating portion 452₃ generates heat over the region of the length L3 right and left with respect to the center C of the heat-generating region in the longitudinal direction such that a set temperature set in advance is reached.

As shown in FIG. 4, the first heat-generating portion 452₁ is used to heat and fix the medium-length recording paper 5 of which a length in a direction intersecting the transport direction of the recording paper 5 is L1.

The second heat-generating portion 452₂ is used at the same time as the first heat-generating portion 452₁ to heat and fix the large-size recording paper 5 of which a length in the direction intersecting the transport direction of the recording paper 5 is L1+2·L2.

The third heat-generating portion 452₃ is used to heat and fix the smallest-size recording paper 5 of which a length in the direction intersecting the transport direction of the recording paper 5 is L3.

As shown in FIG. 2, the holding member 47 is made of, for example, a metallic plate material such as stainless steel, aluminum, or steel. The holding member 47 is formed to have a substantially U-like cross-sectional shape formed by vertical plate portions 471 and 472 that are disposed substantially perpendicular to the surface of the ceramic heater 45 on the upstream side and the downstream side of the fixing nip portion N in a rotational direction of the heating belt 42, and a horizontal plate portion 473 that is disposed in the horizontal direction to connect base end portions of the vertical plate portions 471 and 472.

As shown in FIG. 5, the temperature of the fixing nip portion N of the heating belt 42 is detected by a temperature sensor 49 that is disposed to be in contact with a surface of the ceramic heater 45 that is opposite to the fixing nip portion N. As described above, the ceramic heater 45 includes the first to third heat-generating portions 452₁ to 452₃ having different heat-generating regions in the longitudinal direction. For that reason, a plurality (for example, three) of temperature sensors 49 are disposed in the longitudinal direction of the ceramic heater 45 in correspondence with the first to third heat-generating portions 452₁ to 452₃. The heating belt 42 is heated such that the fixing nip portion N reaches a required fixing temperature (for example, about 200° C.) depending on the size of the recording paper 5 by controlling the energization of the first to third heat-generating portions 452₁ to 452₃ of the ceramic heater 45 on the basis of the detection result of the temperature sensor 49 by a temperature control circuit (not shown).

As shown in FIG. 2, the support member 46 is made of, for example, a heat-resistant synthetic resin integrally molded into a required shape by injection molding or the like. Examples of the heat-resistant synthetic resin include liquid crystal polymer (LCP), polyetheretherketone (PEEK), polyphenylene sulfide (PPS), polyethersulfone (PES), polyamideimide (PAI), polytetrafluoroethylene (PTFE), polychlorotrifluoroethylene (PCTFE), polyvinylidene fluoride (PVDF), or a composite material thereof.

The support member 46 has a support recess portion 461 that supports the ceramic heater 45 to pressurize the pressure roll 43 via the heating belt 42 at the fixing nip portion N and has an elongated rectangular shape corresponding to the planar shape of the ceramic heater 45. The support member 46 is disposed to be longer than the total length in the longitudinal direction of the heating belt 42.

As shown in FIG. 2, the support member 46 is provided with a first guide portion 462 that is formed to have a curved cross-sectional shape and guides the heating belt 42 to the fixing nip portion N on an upstream side with respect to the fixing nip portion N in the rotational direction of the heating belt 42. A lower end surface 463 of the support member 46 is formed in a planar shape. Additionally, on a downstream side with respect to the fixing nip portion N in the rotational direction of the heating belt, the support member 46 is provided with a bent portion 464 that is bent to be closer to an inner side than a curved shape of the heating belt 42 is such that the bent portion 464 does not come into contact with the heating belt 42 passing through the fixing nip portion N.

Additionally, as shown in FIG. 2, the support member 46 is provided with abutment portions 465 and 466 where tips of vertical plate portions 471 and 472 of the holding member 47 abut against a surface of the support member 46 that is opposite to the fixing nip portion N.

As shown in FIG. 2, the pressure roll 43 has a columnar or cylindrical core metal 431 made of metal such as stainless steel, aluminum, or iron (thin-walled high-tension steel pipe), an elastic body layer 432 made of a heat-resistant elastic body such as silicone rubber or fluororubber relatively thickly coated at an outer periphery of the core metal 431, and a release layer 433 made of polytetrafluoroethylene (PTFE), perfluoroalkoxyalkane (PFA), or the like thinly coated on the surface of the elastic body layer 432. In addition, as necessary, a heating section (heating source) including a halogen lamp or the like may be disposed inside the pressure roll 43.

Both end portions in the longitudinal direction (axial direction) of the pressure roll 43 are rotatably supported by a frame of a device housing (not shown) of the fixing device 40 via a bearing member. The pressure roll 43 is rotationally driven at a required speed in a direction of arrow C by the drive device via a drive gear (not shown) attached to one end portion in an axial direction of the core metal 431 that also serves as a rotation shaft. In addition, the heating belt 42 is in pressure contact with the rotationally driven pressure roll 43 and rotates in a driven manner.

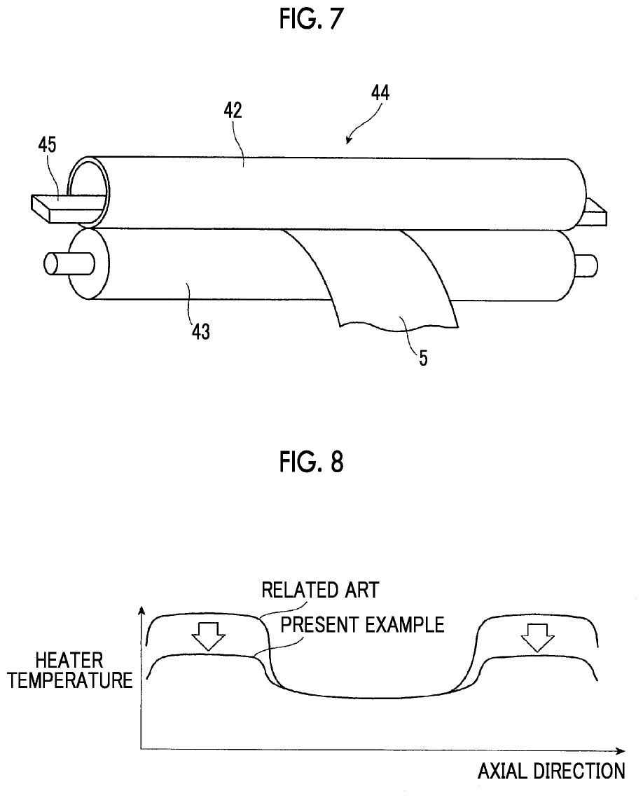

As shown in FIG. 2, in the case of the fixing device 40 configured as described above, the recording paper 5 is transported with the center in the direction intersecting the transport direction of the recording paper 5 as a reference (so-called center registration) and the recording paper 5 is heated and pressurized so that the unfixed toner image T is fixed onto the recording paper 5. Here, regarding the fixing device 40, for example, even in a case where heat is generated with the first to third heat-generating portions 452₁ to 452₃ being switched in accordance with the size of the recording paper 5, there is a case where the size of the recording paper 5 does not coincide with the heat-generating regions of the first to third heat-generating portions 452₁ to 452₃ as in a case where fixation is continuously performed on the small-size recording paper 5 of which the length is relatively small in the longitudinal direction of the heating belt 42 as shown in FIG. 7 and the heat of the heating belt 42 is not drawn by the recording paper 5 in non-paper passage regions positioned at both end portions in the longitudinal direction of the heating belt 42, so that the temperatures of the non-paper passage regions tend to increase as shown in FIG. 8.

Therefore, in the case of a fixing device in the related art, for suppression of an increase in temperature of end portions in a longitudinal direction of a heating section, a technique of providing a high-thermal-conductivity member on a side opposite to an abutment surface with respect to a fixation film of a heating body has been proposed (JP1993-289555A and the like).

However, in a case where the high-thermal-conductivity member is provided on the side opposite to the abutment surface with respect to the fixation film of the heating body, a new technical problem arises in which a time required to heat the heating body to a required fixation start temperature (that is, so-called warm-up time) becomes long at the start of a fixation operation since the heat capacity of the heating body is increased by an amount corresponding to the provided high-thermal-conductivity member.

In Exemplary Embodiment 1, a thermal conduction promoting section that is disposed to be in contact with a surface of a planar heat-generating section that is opposite to a heating target is provided, the thermal conduction promoting section promoting thermal conduction along a longitudinal direction of the planar heat-generating section.

That is, in the case of the fixing device 40 according to Exemplary Embodiment 1, as shown in FIG. 2, two heat pipes 61 and 62 serving as an example of the thermal conduction promoting section and having relatively small outer diameters are provided on a back surface side of the ceramic heater 45.

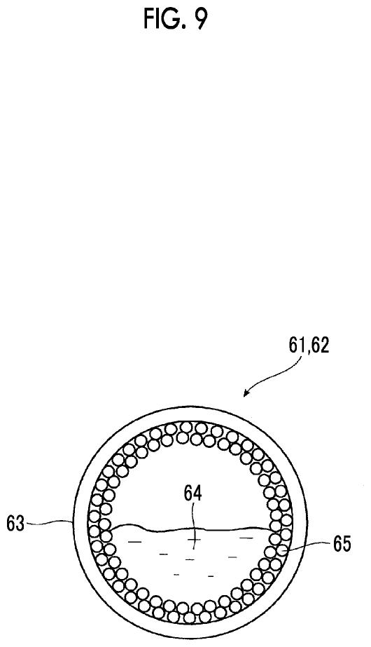

As shown in FIG. 9, each of the heat pipes 61 and 62 includes a pipe body 63 that is formed of metal such as stainless steel and aluminum having a relatively high thermal conductivity and that is formed in an airtight hollow cylindrical shape of which both end portions are closed, a working fluid 64 that consists of liquid such as pure water sealed in the pipe body 63, and wicks 65 serving as an example of a working fluid transport portion (movement section) that is provided over the entire length of an inner peripheral surface of the pipe body 63 and transports the liquefied working fluid 64 along a longitudinal direction of the pipe body by means of a capillary phenomenon. As the wicks 65, for example, fine wires made of copper, sintered metal, wire nets, or the like are used.

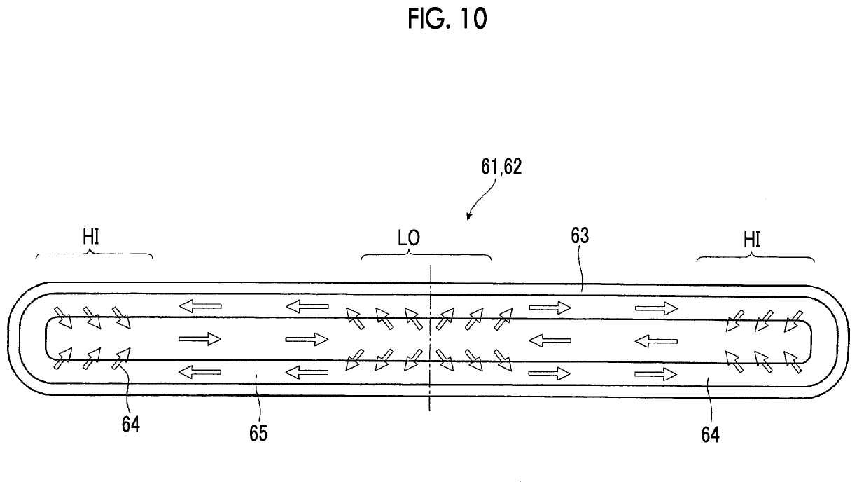

As shown in FIG. 10, in each of the heat pipes 61 and 62, the working fluid 64 sealed therein is vaporized in regions HI, of which the temperatures are relatively high, in a longitudinal direction thereof and the vaporized working fluid 64 is moved to a region, of which the temperature and the pressure are relatively low, in a longitudinal direction of the pipe body 63 due to an increase in pressure caused by vaporization of the working fluid 64. Then, in each of the heat pipes 61 and 62, the vaporized working fluid 64 is liquefied in a region, of which the temperature is relatively low, in the longitudinal direction thereof. Due to the capillary phenomenon attributable to the wicks 65, the liquefied working fluid 64 is moved to a region LO, of which the temperature is relatively low, in the longitudinal direction of the pipe body 63.

In the case of the heat pipes 61 and 62, the above-described operations are performed repeatedly so that a very large amount of heat in comparison with the case of movement of heat made by means of usual thermal conduction or the like is quickly transferred from the regions HI, of which the temperature is relatively high, in the longitudinal direction of the pipe body 63 to the region LO, of which the temperature is relatively low, in the longitudinal direction.

In Exemplary Embodiment 1, as the heat pipes 61 and 62, very thin heat pipes of which the pipe bodies 63 have the outer diameters of 2 to 3 mm are used. As the heat pipes 61 and 62, for example, it is preferable to use heat pipes having a thermal conductivity of 10⁴ (W/m·K) or more. The outer diameters of the heat pipes 61 and 62 are not limited to 2 to 3 mm, and it is a matter of course that the outer diameters may be larger than 2 to 3 mm. However, for example, it is preferable that the heat pipes 61 and 62 have considerably small outer diameters of about 2 to 3 mm because the heat capacities of the heat pipes 61 and 62 are made small in this case.

As shown in FIG. 5, between centers C1 to C3 of the first to third heat-generating portions 452₁ to 452₃ along a direction intersecting the longitudinal direction thereof and inner wall surfaces 467 and 468 of the support member 46, the heat pipes 61 and 62 are disposed to be in contact with a back surface 456 of the ceramic heater 45 that is positioned on a side opposite to the pressure roll 43.

More specifically, on the back surface 456 of the ceramic heater 45 that is positioned on the side opposite to the pressure roll 43 and between the center C1 of the first heat-generating portion 452₁ along the direction intersecting the longitudinal direction thereof and one inner wall surface 467 of the support member 46, the first heat pipe 61 is disposed to be closer to the support member 46 than a position corresponding to the half of a distance L4 between the center C1 of the first heat-generating portion 452₁ along the direction intersecting the longitudinal direction thereof and one inner wall surface 467 of the support member 46 is. From the viewpoint of suppressing an increase in temperature of the support member 46, it is preferable that the first heat pipe 61 is disposed to be in contact with the support member 46, for example.

Meanwhile, on the back surface 456 of the ceramic heater 45 that is positioned on the side opposite to the pressure roll 43 and between the center C3 of the third heat-generating portion 452₃ along the direction intersecting the longitudinal direction thereof and the inner wall surface 468 of the support member 46, the second heat pipe 62 is disposed to be closer to the support member 46 than a position corresponding to the half of a distance L5 between the center C3 of the third heat-generating portion 452₃ along the direction intersecting the longitudinal direction thereof and the other inner wall surface 468 of the support member 46. From the viewpoint of suppressing an increase in temperature of the support member 46, it is preferable that the second heat pipe 62 is also disposed to be in contact with the support member 46, for example.

In addition, although the second heat pipe 62 is disposed to partially overlap with the third heat-generating portion 452₃ of the ceramic heater 45 in the example shown in the drawing, generated heat is not directly transferred to the ceramic heater from the third heat-generating portion 452₃ or a very small amount of heat is transferred to the ceramic heater since the ceramic heater 45 is configured such that heat is basically not generated or a very small amount of heat is generated even in the case of heat generation at regions where the line widths are large as described above.

Meanwhile, the heat pipes 61 and 62 generally made of copper and the like, which are metals having a high thermal conductivity, are not supposed to be used at a high temperature of about 200° C. unlike the ceramic heater 45 of the fixing device 40.

Therefore, according to a study of the present inventors, an oxidation reaction as shown by the following chemical formula occurs in a case where copper and water are in contact with each other for a long period of time at a high temperature of about 200° C. although copper and water are usually inert.

H₂O+Cu⇔CuO+H₂

Since hydrogen (H₂) generated by the oxidation reaction stays as an inert gas inside the heat pipes 61 and 62, movement of water vapor is hindered and the thermal conduction performance of the heat pipes 61 and 62 is lowered.

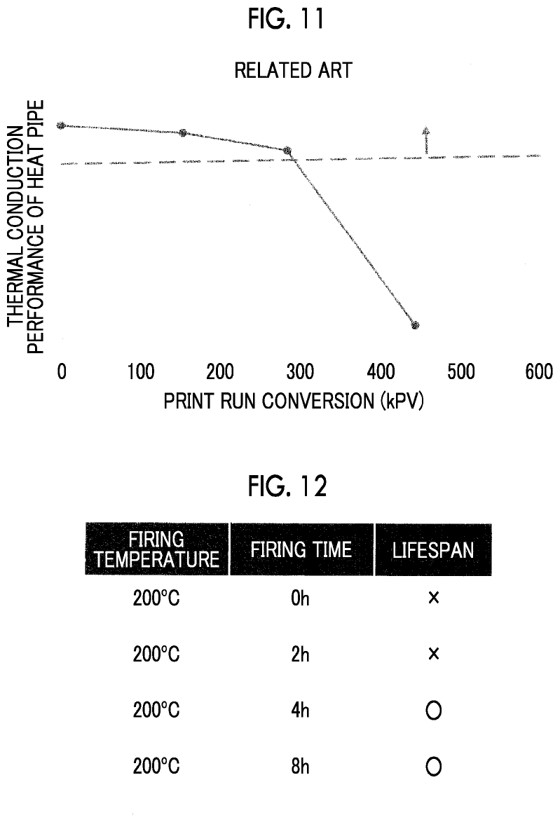

As a result, according to a study by the present inventors, in a case where the cumulative number of sheets of recording paper 5 to be subjected to a fixing treatment in the fixing device 40 reaches around 300 kPV (300,000 sheets), the thermal conduction performance of the heat pipes 61 and 62 is sharply lowered as shown in FIG. 11 and thus an increase in temperature at both end portions of the ceramic heater 45 in the longitudinal direction cannot be suppressed.

Therefore, a heat pipe according to Exemplary Embodiment 1 is configured to include a tubular member that is a hollow member in which liquid is encapsulated and of which an inner surface is subjected to an oxidation treatment in advance and a movement section that moves the liquid encapsulated and liquefied in the tubular member along a longitudinal direction of the tubular member by means of a capillary phenomenon and of which a surface is subjected to an oxidation treatment in advance.

That is, in a step of manufacturing the heat pipes 61 and 62 according to Exemplary Embodiment 1, instead of injecting pure water serving as an example of a working fluid into the pipe body 63 and encapsulating the pure water after the wicks 65 consisting of fine copper wires or the like are accommodated to be on the inner peripheral surface of the pipe body 63 of which one end portion in the longitudinal direction is sealed and that is made of metal such as copper, an oxidation step of oxidizing an inner surface of the pipe body 63 and surfaces of the wicks 65 in advance is performed after the wicks 65 consisting of fine copper wires or the like are accommodated to be on the inner peripheral surface of the pipe body 63.

The oxidation step is performed by inserting the pipe body 63 into a high-temperature furnace and heating (firing) the pipe body 63 in a state where the wicks 65 are accommodated to be on the inner peripheral surface of the pipe body 63 and the other end portion of the pipe body 63 in the longitudinal direction is open so that the pipe body 63 and the wicks 65 made of metal such as copper or the like are subjected to an oxidation treatment by being caused to react with oxygen in the air and an oxide is generated.

The temperature of the inside of the high-temperature furnace is set to, for example, a temperature of about 200° C. which is approximately equal to the fixing temperature of the fixing device 40, or a temperature of about 245° C., which is higher than the fixing temperature. Additionally, as shown in FIG. 12, it is preferable that a time for which an oxidation treatment is performed by firing the inner peripheral surface of the pipe body 63 and the surfaces of the wicks 65 is set to a time equal to or greater than a time of four hours, which serves as an example of a first time, and equal to or smaller than a time of eight hours, which serves as an example of a second time, for example.

In a case where a firing time is smaller than four hours, the inner peripheral surface of the pipe body 63 and the surfaces of the wicks 65 may be insufficiently subjected to an oxidation treatment and in a case where the firing time exceeds eight hours, the inner peripheral surface of the pipe body 63 and the surfaces of the wicks 65 may be excessively subjected to an oxidation treatment and the excessive oxidation treatment of the inner peripheral surface of the pipe body 63 and the surfaces of the wicks 65 may cause minute roughness, which hinders the capillary phenomenon in the case of movement in the longitudinal direction of liquefied water.

Operation of Fixing Device

In the case of the fixing device according to Exemplary Embodiment 1, a heat pipe, of which a favorable thermal conduction performance may be maintained along a longitudinal direction for a long period of time, and a fixing device and an image forming apparatus using the heat pipe may be provided as follows.

That is, in the case of the fixing device 40 according to Exemplary Embodiment 1, as shown in FIG. 2, at least one or more of the first to third heat-generating portions 452₁ to 452₃ of the ceramic heater 45 generates heat to heat the heating belt 42.

The heated heating belt 42 rotates together with the pressure roll 43 in the direction of arrow C in FIG. 2 and performs a fixing treatment by heating and pressurizing the recording paper 5 holding the unfixed toner image T at the fixing nip portion N.

In the case of the fixing device 40, each time the fixing treatment is performed, at least one or more of the first to third heat-generating portions 452₁ to 452₃ of the ceramic heater 45 generates heat and the heat pipes 61 and 62 disposed on the back surface side of the ceramic heater 45 are heated to a high temperature of about 200° C. together with the ceramic heater 45. Then, in a case where the fixing treatment is completed, the energization of the ceramic heater 45 is finished and the fixing device 40 is cooled to a temperature equal to the room temperature and maintained at the temperature equal to the room temperature until the next fixing treatment is started.

Meanwhile, the heat pipes 61 and 62 include the pipe bodies 63 and the wicks 65 made of metal such as copper and are configured such that pure water is encapsulated therein.

Although copper, which is metal material constituting the pipe bodies 63 and the wicks 65 of the heat pipes 61 and 62, and water are usually inert, an oxidation reaction as shown by the following chemical formula occurs in a case where copper and water are in contact with each other for a long period of time at a high temperature of about 200° C. which is the fixing temperature of the fixing device 40.

H₂O+Cu⇔CuO+H₂

However, in the case of the fixing device 40 according to Exemplary Embodiment 1, the pipe bodies 63 and the wicks 65 of the heat pipes 61 and 62 are subjected to an oxidation treatment in advance. Therefore, in the case of the heat pipes 61 and 62, an oxidation reaction in which copper is oxidized and hydrogen (H₂) is generated does not occur or is suppressed even in a case where copper and water are in contact with each other for a long period of time at a high temperature of about 200° C.

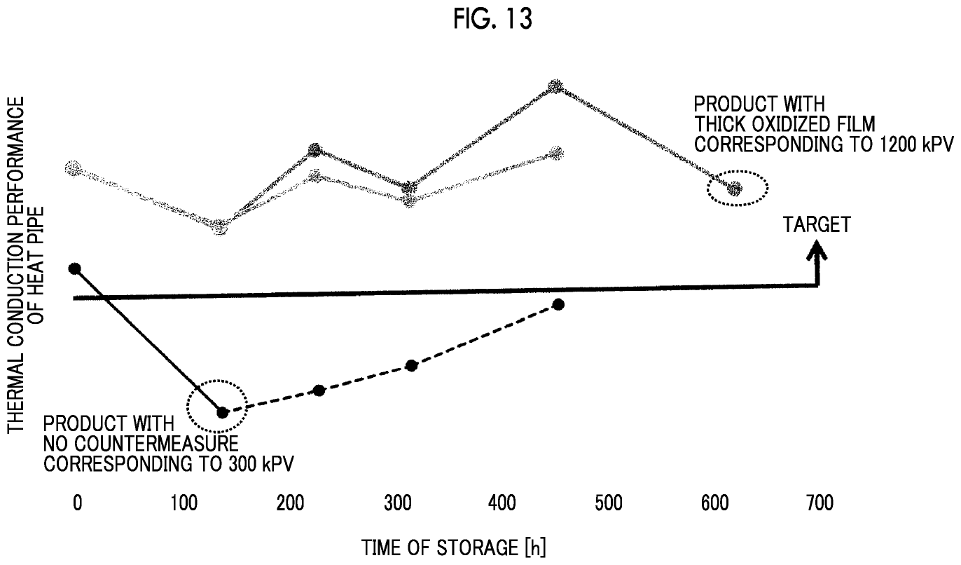

Therefore, in the case of the fixing device 40 according to Exemplary Embodiment 1, as shown in FIG. 13, a decrease in thermal conduction performance caused by oxidation of the pipe bodies 63 and the wicks 65 of the heat pipes 61 and 62 is suppressed even in a case where the fixing device 40 is used for a long period of time and a favorable thermal conduction performance may be maintained until the end of the lifespan of the fixing device 40 is reached.

In addition, in FIG. 13, the thermal conduction performance of the heat pipes 61 and 62, which temporarily decreases in a certain period, tends to increase again. It is considered that this is because the oxidation reaction between copper and water is a reversible reaction and hydrogen (H₂) generated by the oxidation reaction between copper and water reacts with oxygen (O) of copper oxide (CuO) and turns back into water (H₂O).

In addition, in the above exemplary embodiments, the case where the ceramic heater is used as the planar heat-generating section has been described, but the planar heat-generating section is not limited to the ceramic heater, and anything that generates heat literally in a planar manner at the fixing nip portion N may be used.

Additionally, in the above-described exemplary embodiments, the case where the pressure roll is used as the pressurizing section has been described, but a pressure belt may be used as the pressurizing section.

Additionally, although the present invention has been described with the electrophotographic image forming apparatus, the present invention is not limited to the electrophotographic image forming apparatus. For example, it is also possible to apply the present invention to an ink jet type image forming apparatus or the like in which an unfixed ink image is fixed on paper in contact with the paper transported while holding an image of an undried layer with ink (an unfixed ink image).

Supplementary Note

(((1)))

A heat pipe comprising:
a tubular member that is a hollow member in which liquid is encapsulated and of which an inner surface is subjected to an oxidation treatment in advance; and
a movement section that moves the liquid encapsulated and liquefied in the tubular member along a longitudinal direction of the tubular member by means of a capillary phenomenon and of which a surface is subjected to an oxidation treatment in advance.

(((2)))

The heat pipe according to (((1))),
wherein the tubular member and the movement section are subjected to the oxidation treatment by being heated before encapsulation of the liquid.

(((3)))

The heat pipe according to (((2))),
wherein the oxidation treatment of the tubular member and the movement section is performed to such a degree that movement of the liquefied liquid along the longitudinal direction of the tubular member is not hindered, the movement being caused by the capillary phenomenon.

(((4)))

The heat pipe according to (((3))),
wherein the oxidation treatment of the tubular member and the movement section is performed for a time longer than a first time and shorter than a second time.

(((5)))

The heat pipe according to (((1))),
wherein the liquid consists of pure water.

(((6)))

The heat pipe according to (((5))),
wherein the tubular member and the movement section react with the pure water, so that an oxide is generated.

(((7)))

A fixing device comprising:
a heating section that heats a fixation target member; and a heat pipe that comes into contact with the heating section,
wherein the heat pipe according to any one of (((1))) to (((6))) is used as the heat pipe.

(((8)))

An image forming apparatus comprising:
an image forming section that forms an image on a recording medium; and
a fixing section that fixes the image on the recording medium,
wherein the fixing device according to (((7))) is used as the fixing section.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A heat pipe comprising:
a tubular member that is a hollow member in which liquid is encapsulated and of which an inner surface is subjected to an oxidation treatment in advance; and
a movement section that moves the liquid encapsulated and liquefied in the tubular member along a longitudinal direction of the tubular member by means of a capillary phenomenon and of which a surface is subjected to an oxidation treatment in advance.

2. The heat pipe according to claim 1,
wherein the tubular member and the movement section are subjected to the oxidation treatment by being heated before encapsulation of the liquid.

3. The heat pipe according to claim 2,
wherein the oxidation treatment of the tubular member and the movement section is performed to such a degree that movement of the liquefied liquid along the longitudinal direction of the tubular member is not hindered, the movement being caused by the capillary phenomenon.

4. The heat pipe according to claim 3,
wherein the oxidation treatment of the tubular member and the movement section is performed for a time longer than a first time and shorter than a second time.

5. The heat pipe according to claim 1,
wherein the liquid consists of pure water.

6. The heat pipe according to claim 5,
wherein the tubular member and the movement section react with the pure water, so that an oxide is generated.

7. A fixing device comprising:
a heating section that heats a fixation target member; and
a heat pipe that comes into contact with the heating section,
wherein the heat pipe according to claim 1 is used as the heat pipe.

8. A fixing device comprising:
a heating section that heats a fixation target member; and
a heat pipe that comes into contact with the heating section,
wherein the heat pipe according to claim 2 is used as the heat pipe.

9. A fixing device comprising:
a heating section that heats a fixation target member; and
a heat pipe that comes into contact with the heating section,
wherein the heat pipe according to claim 3 is used as the heat pipe.

10. A fixing device comprising:
a heating section that heats a fixation target member; and
a heat pipe that comes into contact with the heating section,
wherein the heat pipe according to claim 4 is used as the heat pipe.

11. A fixing device comprising:
a heating section that heats a fixation target member; and
a heat pipe that comes into contact with the heating section,
wherein the heat pipe according to claim 5 is used as the heat pipe.

12. A fixing device comprising:
a heating section that heats a fixation target member; and
a heat pipe that comes into contact with the heating section,
wherein the heat pipe according to claim 6 is used as the heat pipe.

13. An image forming apparatus comprising:
an image forming section that forms an image on a recording medium; and
a fixing section that fixes the image on the recording medium,
wherein the fixing device according to claim 7 is used as the fixing section.

14. An image forming apparatus comprising:
an image forming section that forms an image on a recording medium; and
a fixing section that fixes the image on the recording medium,
wherein the fixing device according to claim 8 is used as the fixing section.

15. An image forming apparatus comprising:
an image forming section that forms an image on a recording medium; and
a fixing section that fixes the image on the recording medium,
wherein the fixing device according to claim 9 is used as the fixing section.

16. An image forming apparatus comprising:
an image forming section that forms an image on a recording medium; and
a fixing section that fixes the image on the recording medium,
wherein the fixing device according to claim 10 is used as the fixing section.

17. An image forming apparatus comprising:
an image forming section that forms an image on a recording medium; and
a fixing section that fixes the image on the recording medium,
wherein the fixing device according to claim 11 is used as the fixing section.

18. An image forming apparatus comprising:
an image forming section that forms an image on a recording medium; and
a fixing section that fixes the image on the recording medium,
wherein the fixing device according to claim 12 is used as the fixing section.

19. A heat pipe comprising:
a tubular member that is a hollow member in which liquid is encapsulated and of which an inner surface is subjected to an oxidation treatment in advance; and
movement means for moving the liquid encapsulated and liquefied in the tubular member along a longitudinal direction of the tubular member by means of a capillary phenomenon, of which a surface is subjected to an oxidation treatment in advance.
